(19) United States
(12) Patent Application Publication
(10) Pub. No.: US 2009/0065290 A1
(43) Pub. Date: Mar. 12, 2009

(54) INTERFLOOR NOISE REDUCTION PANEL WITH AIR PURIFYING AND STERILIZING FUNCTIONS FOR BUILDING

(76) Inventor: Bu Yeol KIM, Ansan-si (KR)

Correspondence Address: IPLA P.A., 3580 WILSHIRE BLVD., 17TH FLOOR, LOS ANGELES, CA, 90010, US

(21) Appl. No.: 12/206,496

(22) Filed: Sep. 8, 2008

(30) Foreign Application Priority Data
Sep. 6, 2007 (KR) 10-2007-0090357

(51) Int. Cl. E04B 1/82; B01D 47/00; E04B 1/88

(52) U.S. Cl. 181/141; 96/223; 181/290

(57) ABSTRACT

An interfloor noise reduction panel with an air purifying function for buildings is capable of reducing impact due to the dropping of a weight and electromotive forces of machinery as well as noise and vibration transmitted through the floor of the building through the structure in which a plurality of springs, a sound-absorbing material, an ion mortar layer are disposed in a base panel such that noise generated by pressure applied to the panel above is absorbed and thus maximally extinguished.

### CROSS REFERENCE

This application claims foreign priority under Paris Convention and 35 U.S.C. §119 to Korean Patent Application No. 10-2007-0090357, filed Sep. 8, 2008 with the Korean Intellectual Property Office.

### BACKGROUND OF THE INVENTION

1. Field of the Invention

The present invention relates to the reduction of interfloor noise in apartment houses, office buildings, and factories, and more particularly, to an interfloor noise reduction panel with an air purifying function for buildings that is capable of reducing impact due to the dropping of a weight and electromotive forces of machinery as well as noise and vibration transmitted through the floor of the building through the structure in which a plurality of springs, a sound-absorbing material, an ion mortar layer are disposed in a base panel such that noise generated by pressure applied to the panel above is absorbed and thus maximally extinguished, and holes are formed in an upper panel such that a sound absorption effect is improved through the holes of the upper panel, and purifying air through the breakage of molecular rings of volatile organic compounds generated from interior decoration materials of the apartment houses and the office buildings by the reaction between far-infrared rays and negative ions generated from ion substances of mortar filled in the lower part of the panel and the volatile organic compounds.

2. Description of the Related Art

Generally, impact generated during the movement of room furniture and walking of an inhabitant in a multi-storied house, especially an apartment house, is transmitted to the floor, with the result that another inhabitant on the neighboring floor feels uncomfortable, which leads to the inconvenience of living and quarrels, and therefore, public resentment increases. For this reason, the housing construction standard prescribes that impact sound per pyeong generated when a small-sized object drops should be 58 decibel or less, and weight impact sound corresponding to sound generated when children run and play should be 50 decibel or less, as a limit reference of interfloor noise. From now on, the construction and transportation department is going to strengthen the limit reference of interfloor noise according to the well-being tendency of apartment houses. Consequently, much effort and research are in progress to prevent the generation of interfloor noise in apartment houses, which is a cause of noise-related quarrels.

As an example, there has been proposed an interfloor noise reduction panel constructed in a structure in which a plurality of micro holes are formed in a light-weight and soft Styrofoam board having a weight per unit area of 6 to 9 kg/m² to absorb sound through the micro holes. As another example, there has been proposed an interfloor noise reduction panel disposed on a slab and constructed in a structure in which a housing has bottom parts protruding convexly downward toward their centers and a receiving part the circumference of which is surrounded by a frame, and the receiving part is filled with foam and aerated concrete, thereby achieving sound insulation and sound absorption.

FIGS. 1 and 2 are views illustrating conventional interfloor noise reduction panels for buildings. Referring to FIG. 1, a conventional interfloor noise reduction panel for buildings (Registered Utility Model Registration No. 20-0401294) is constructed in a structure in which a Styrofoam board is provided at one side of the panel, and a plurality of micro holes are formed in the board.

FIG. 2 is a view illustrating the structure of another conventional interfloor noise reduction panel (Utility Model Registration No. 20-0422309-000). Referring to FIG. 2, the panel includes a housing having bottom parts protruding convexly downward toward their centers and a receiving part the circumference of which is surrounded by a frame, the receiving part being filled with foam and aerated concrete.

However, the above-discussed conventional interfloor noise reduction panels cannot rapidly disperse pressure transmitted from the upper part of a building. Also, the foam and the Styrofoam have low density, and therefore, a great sound absorption effect is not expected. Furthermore, vibration from the building is transmitted to the floor of the building, with the result that above-discussed conventional interfloor noise reduction panels are limited in reducing high noise due to the resonance of a wave motion.

### SUMMARY OF THE INVENTION

Therefore, the present invention has been made in view of the above problems, and it is an object of the present invention to provide an interfloor noise prevention panel with an air purifying function for buildings that is capable of reducing impact due to the dropping of a weight and electromotive forces of machinery as well as noise and vibration transmitted through the floor of the building and having air purifying and sterilizing functions.

In accordance with the present invention, the above object can be accomplished by the provision of an interfloor noise reduction panel with air purifying and sterilizing functions for buildings, including a lower plate having an approximately rectangular body, which is horizontally installed at the floor of the building in contact with the floor to reduce noise transmitted to the floor, a vibration-proof layer disposed on the lower plate for damping and absorbing vibration and impact transmitted to the lower plate with elastic energy to alleviate a wave resonance effect of the floor, a negative ion mortar layer disposed between the lower plate and the vibration-proof layer to purify contaminated room air with far-infrared rays and negative ions generated from the negative ion mortar layer, a porous sound-absorbing material disposed on the negative ion mortar layer to absorb noise energy incident upon the panel with the resistance of a porous fiber material, and an upper plate for covering the porous sound-absorbing material, the upper plate having a plurality of sound-absorbing holes formed therein for, after the noise energy incident upon the panel is absorbed by the porous sound-absorbing material and the negative ion mortar layer, absorbing the remaining noise energy.

Preferably, the lower plate is formed of any one selected from a group consisting of steel, aluminum, and concrete constructed such that the weight and planar density of a material that is capable of reducing energy incident upon or transmitted through the interfloor noise reduction panel for buildings to greatly improve a sound insulation effect are maintained densely. More preferably, a guide plane having at least one panel fixing hole formed therein is attached to the lower plate such that the guide plane extends outward. The interfloor noise reduction panel further includes a vibration-proof rubber plate or a felt plate attached to the bottom of the lower plate for reducing the transmission of solid-borne sound to the panel. Also, the vibration-proof layer includes a plurality of springs or vibration-proof rubber members having a great selection range with respect to the number of natural frequencies transmitted to the panel, a damping efficiency, high low-frequency vibration insulation, and high heat resistance. The negative ion mortar layer includes a mixture of one or more selected from a group consisting of illite, tourmaline, geolite, and pottery stone disposed between the springs on the lower plate for purifying contaminated room air and sterilizing microorganisms inhabiting a room with far-infrared rays and negative ions emitted from the mortar layer, and natural inorganic matter disposed between the springs on the lower plate for controlling humidity through a large number of micro pores formed at the surface thereof.

The porous sound-absorbing material has high density and is treated to have fire retardancy, thereby absorbing the noise energy, i.e., wave energy of a sound wave, through an irreversible change process into the form of thermal energy. The porous sound-absorbing material is made of a foam resin material and an inorganic fiber sound-absorbing material that is soft, rough at the surface thereof, porous, has a good sound-absorption property at a middle and high sound range, and has a sound absorption property at a low sound range increased by increasing the thickness of the material and the thickness of a discharged air layer. The porous sound-absorbing material is made of polyurethane foam fiber or rock wool that stores solid-borne sound transmitted into the panel, mechanical energy, and noise energy by the viscosity of air between a plurality of fiber layers of the porous sound-absorbing material. The interfloor noise reduction panel further includes a piston pin attached to at least one of the corners and the central part of the panel, such that the piston pin extends downward from the upper plate, for preventing the separation between the lower plate and the upper plate due to external impact, and a sleeve mounted in the lower plate for receiving the piston pin. The interfloor noise reduction panel further includes a separation preventing member including a pair of connection rings and a rope connected between the connection rings for preventing the lower plate and the upper plate from separating from each other due to external impact and vibration applied to the panel. The interfloor noise reduction panel further includes pipe penetration holes formed between the lower plate and the upper plate for allowing cooling or heating pipes to penetrate therethrough, thereby preventing the interference between the cooling or heating pipes and the interfloor noise reduction panel.

The present invention with the above-stated construction has the effect of insulating impact and interfloor noise transmitted from the floor of an apartment house, an office building, and a factory using a steel sheet having a high specific gravity to increase weight per unit area and thus increase transmission loss [TL=10 log(li/lt)], preventing vibration using vibration-proof springs having a high coefficient of elasticity, absorbing wave energy of a sound wave, through an irreversible change process into the form of thermal energy using a porous sound-absorbing material which has a high density and is treated to have fire retardancy, improving sound absorption efficiency using an upper plate having holes formed at the surface thereof, purifying room air using far-infrared rays and negative ions emitted from a natural inorganic mortar layer, easily achieving the disassembly and installation of the panel through holes, having a diameter of approximately 5 mm, formed in guide planes of a lower plate of the panel considering the convenience of construction.

That is, the interfloor noise prevention panel with an air purifying function for apartment houses, office buildings, and factories has the advantage of purifying contaminated room air using far-infrared rays and negative ions generated from the negative ion mortar layer, insulating sound from the lower plate (steel) of the panel through the multi-layered panel including the lower plate, the vibration-proof springs, the negative ion mortar layer, the porous sound-absorbing material, the upper plate, and the pipe insertion holes, achieving vibration prevention through the elastic deformation of the vibration-proof springs, achieving sound absorption using the porous sound-absorbing material, improving sound absorption efficiency through a plurality of holes formed at the surface of the upper plate of the panel, achieving the easiness of construction by the provision of holes formed in the guide planes of the lower plate of the panel, achieving heat insulation by the negative ion mortar layer and the porous sound-absorbing material, epochal reduction of interfloor noise and vibration by the provision of cooling and heating pipe penetration holes, and saving energy through the heat insulation.

### BRIEF DESCRIPTION OF THE DRAWINGS

FIGS. 1 and 2 are views illustrating conventional interfloor noise reduction panels for buildings;

FIG. 3 is a perspective view illustrating principal parts of an interfloor noise prevention panel with an air purifying function for buildings according to the present invention;

FIG. 4 is a longitudinal sectional view illustrating the structure of the interfloor noise prevention panel for buildings shown in FIG. 3;

FIG. 5 is an enlarged view of a lower plate shown in FIGS. 3 and 4;

FIG. 6 is a longitudinal sectional view illustrating the structure of springs, an example of a vibration-proof layer, shown in FIGS. 3 and 4;

FIG. 7 is a view illustrating the installed state of the springs shown in FIG. 6;

FIG. 8 is a structural view illustrating a principle of generating negative ions by a negative ion mortar layer shown in FIGS. 3 and 4;

FIG. 9 is a longitudinal sectional view illustrating the structure of a porous sound-absorbing material shown in FIGS. 3 and 4;

FIG. 10 is a view illustrating an upper plate shown in FIGS. 3 and 4;

FIG. 11 is a structural view illustrating the installation of piston pins, sleeves, and separation preventing members shown in FIGS. 3 and 4;

FIG. 12 is an enlarged view illustrating the installed state of one piston pin and one corresponding sleeve shown in FIG. 11;

FIG. 13 is an enlarged view of the separation preventing member shown in FIG. 11; and

FIG. 14 is a structural view illustrating the construction of interfloor noise prevention panels with an air purifying function for buildings according to the present invention.

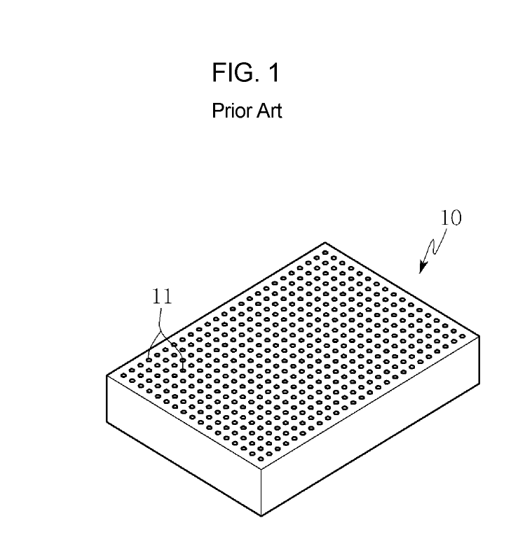

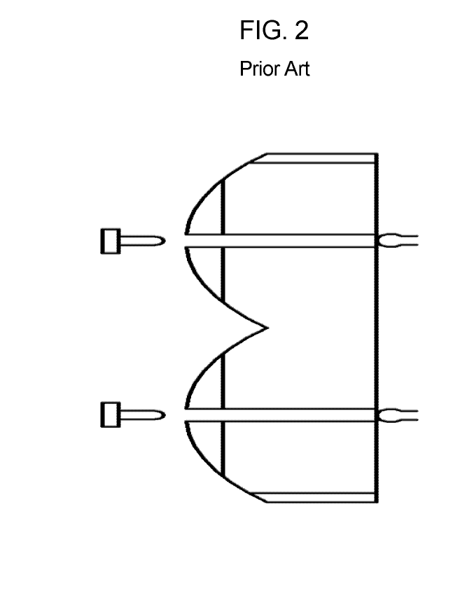

### DETAILED DESCRIPTION OF THE PREFERRED EMBODIMENTS

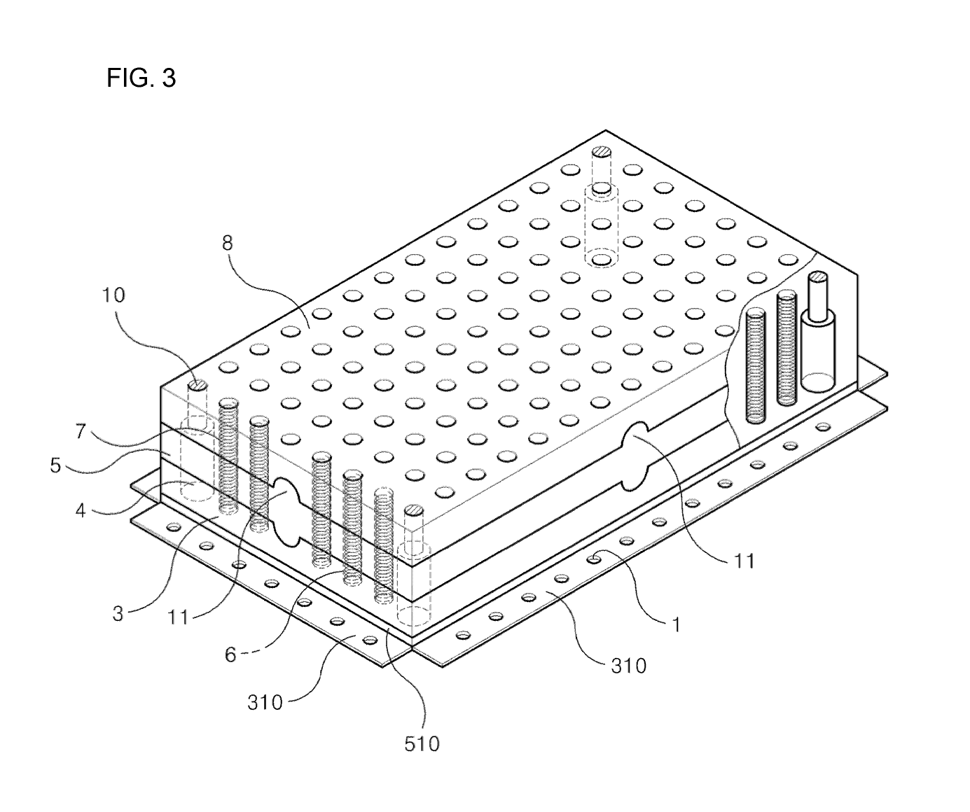

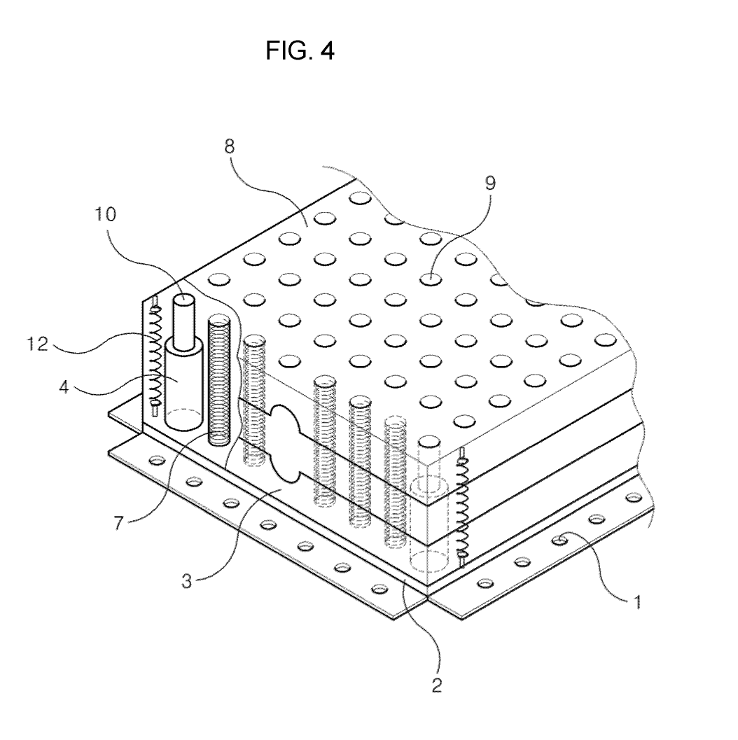

Now, an interfloor noise reduction panel with air purifying and sterilizing functions for buildings according to a preferred embodiment of the present invention will be described in detail with reference to the accompanying drawings. FIG. 3 is a perspective view illustrating principal parts of an interfloor noise prevention panel with an air purifying function for buildings according to the present invention, and FIG. 4 is a longitudinal sectional view illustrating the structure of the interfloor noise prevention panel for buildings shown in FIG. 3.

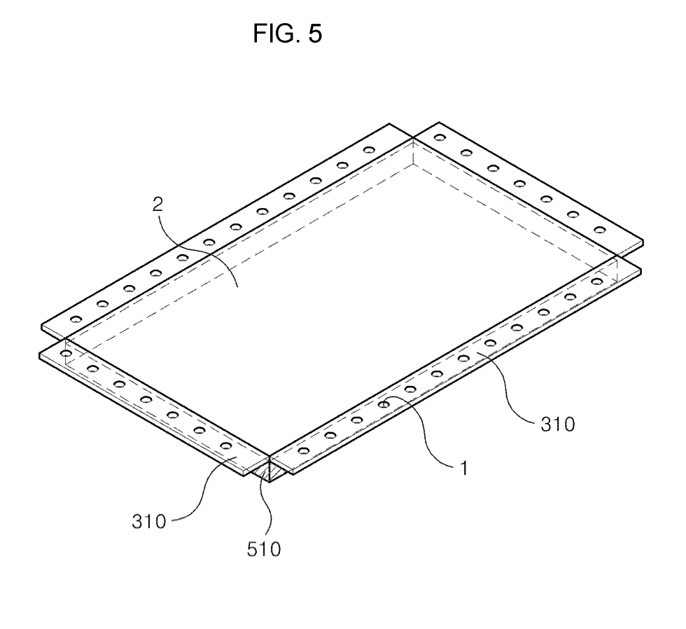

FIG. 5 is an enlarged view of a lower plate shown in FIGS. 3 and 4.

The interfloor noise reduction panel with air purifying and sterilizing functions for buildings according to the present invention includes a lower plate 2, a vibration-proof layer, a negative ion mortar layer 3, a porous sound-absorbing material 5, and an upper plate 8.

The interfloor noise reduction panel for buildings is a dry support system panel made of an steel sheet (a specific gravity of 7.9) of a very great sound insulation effect and having a plurality of panel fixing holes 1, through which the panel is easily installed at and disassembled from the floor of a building at four sides, including opposite sides, of the lower part of the panel.

The lower plate 2 has an approximately rectangular body, which is horizontally installed at the floor of the building in contact with the floor to reduce noise transmitted to the floor.

The lower plate 2 is formed of any one selected from a group consisting of steel, aluminum, and concrete constructed such that the weight and planar density of a material that is capable of reducing energy incident upon or transmitted through the interfloor noise reduction panel for buildings to greatly improve a sound insulation effect are maintained densely. The steel (a specific gravity of 7.9), the aluminum (a specific gravity of 7.9), or the concrete, which is harmless to people and has a high specific gravity, is used as the sound insulation material, and a mass law ruled by the weight and planar density of the material is applied to greatly increase transmission loss, thereby improving sound insulation efficiency. According to the present invention, the lower plate 2 uses a steel sheet having a high specific gravity as the sound insulation material to reduce impact transmitted from the floor of an apartment house, an office building, or a factory or interfloor noise to greatly increase the weight per unit area, thereby increasing transmission loss {TL=10 log(li/lt)} and thus insulating sound.

FIG. 5 is an enlarged view of the lower plate 2 shown in FIGS. 3 and 4.

Referring to FIG. 5, guide planes 310 having a size of approximately 2 cm are formed at four sides of the lower plate 2 of the panel. In the guide planes 310 are formed panel fixing holes 1 having a size of approximately 5 to 10 mm, through which it is possible to easily separate and disassemble the panel. That is, each guide plane 310 having at least one panel fixing hole 1 formed therein is attached to the lower plate 2, such that each guide plane 310 extends outward, for easy installation and disassembly of the interfloor noise reduction panel.

The lower plate 2 further includes a vibration-proof rubber plate or a felt plate 510 attached to the bottom of the lower plate 2 and the guide planes 310 for reducing the transmission of solid-borne sound to the panel.

The vibration-proof layer is disposed on the lower plate 2 for damping and absorbing vibration and impact transmitted to the lower plate 2 with elastic energy to alleviate a wave resonance effect of the floor.

The vibration-proof layer includes a plurality of springs or vibration-proof rubber members having a great selection range with respect to the number of natural frequencies transmitted to the panel, a damping efficiency, high low-frequency vibration insulation, and high heat resistance.

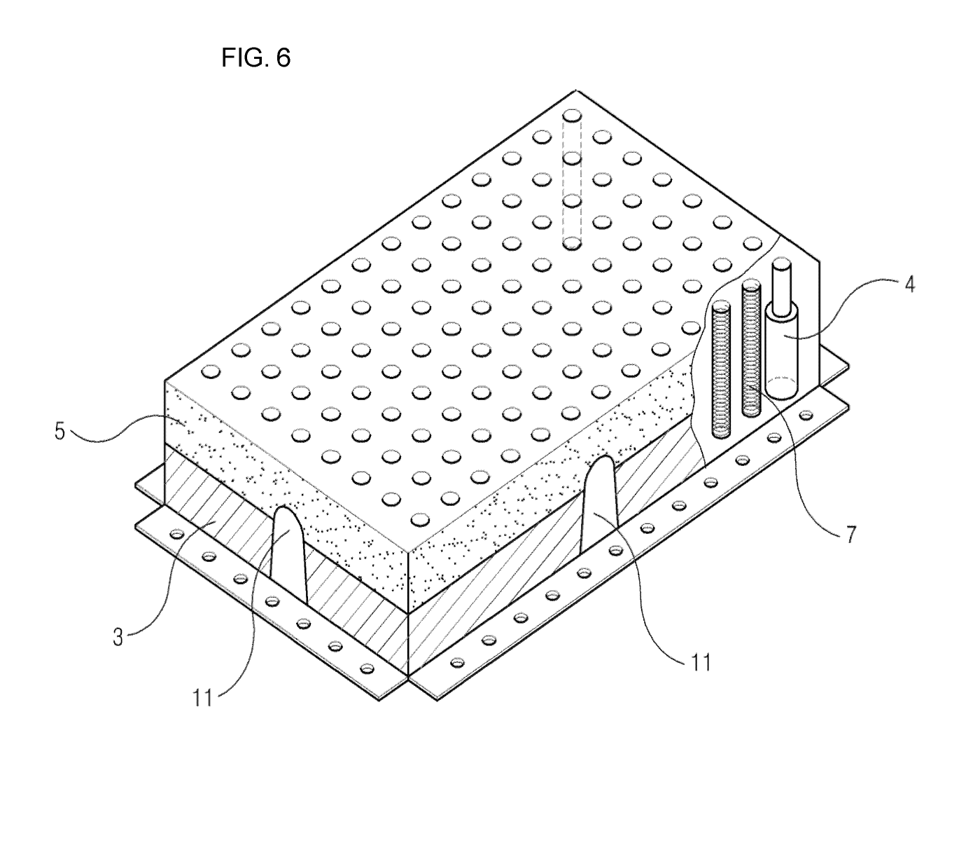

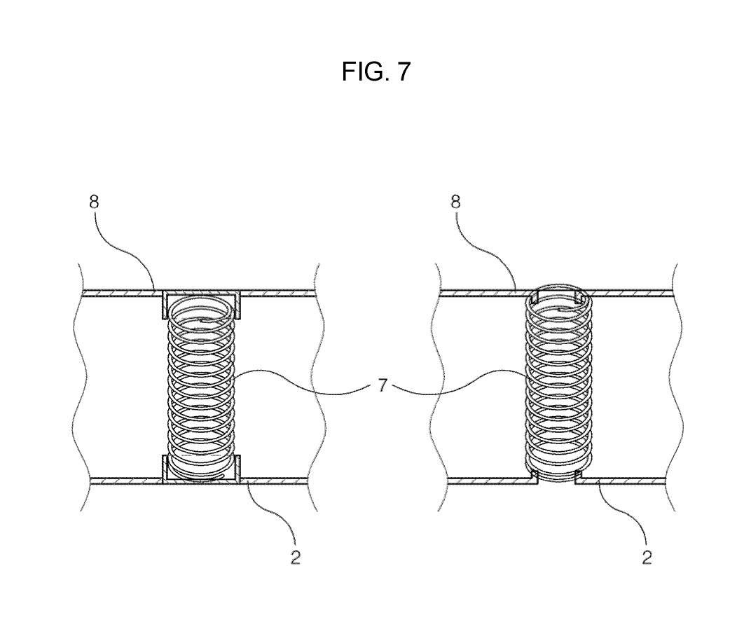

FIG. 6 is a longitudinal sectional view illustrating the structure of springs, an example of the vibration-proof layer, shown in FIGS. 3 and 4. FIG. 7 is a view illustrating the installed state of the springs shown in FIG. 6.

According to the present invention, a plurality of springs having a high coefficient of elasticity are used, as the vibration-proof layer, to damp and absorb vibration and impact transmitted to the lower plate 2 with elastic energy to alleviate a wave resonance effect of the floor.

The springs 7 damp impact applied to the lower plate 2 of the panel, electromotive forces of machinery, and wave resonance energy of the floor due to vibration transmitted to the lower plate 2 of the panel with elastic energy inherent in the springs.

Specifically, the plurality of springs 7 are installed on the lower plate 2 of the panel to absorb impact applied to the upper plate 8 of the panel and the electromotive forces of machinery with torsional elastic strain energy of the springs 7

$$( u 1 = \frac{T θ}{2} = \frac{WK}{2} ( \frac{64 {WR}^{2} n}{{Gd}^{4}} ) = \frac{3 {W}^{2} {R}^{3} n}{{Gd}^{4}} [ N . m ] )$$

and elastic energy due to an external force W

$$( u 2 = \frac{ωδ}{2} [ N . m ] )$$

to prevent vibration from being transmitted to the floor of the building.

Metal springs exhibit high resistance against environmental factors, such as temperature, corrosion, and dissolution, are not distorted, are not compressed, and have maximally allowable displacement, and therefore, the metal springs are very effective to insulate low-frequency vibration. Furthermore, there is little damping, and the transmissivity is very high during the resonance, whereby it is required to pay attention such that rocking does not occur. In order to complement such drawbacks, the present invention is characterized in that dampers are installed in parallel to the springs, and such that a static compression amount ζ of the springs is uniform to restrain the rocking movement, to calculate the number of effective windings of the springs

$$( n = \frac{64 {WR}^{3} n}{8 {WC}^{3}} = \frac{8 {WD}^{3} n}{{Gd}^{4}} = \frac{8 {W [ \frac{D}{d} ]}^{3} n}{Gd} = \frac{8 {WC}^{3} n}{Gd} )$$

and then manufacture the springs.

The negative ion mortar layer 3 is disposed on the lower plate 2, such that the negative ion mortar layer 3 is filled between the springs 7, as the vibration-proof layer, by a predetermined thickness or more, to purify contaminated room air and sterilize microorganisms inhabiting a room with far-infrared rays and negative ions generated from the negative ion mortar layer and control humidity through a large number of micro pores formed at the surface of the negative ion mortar layer.

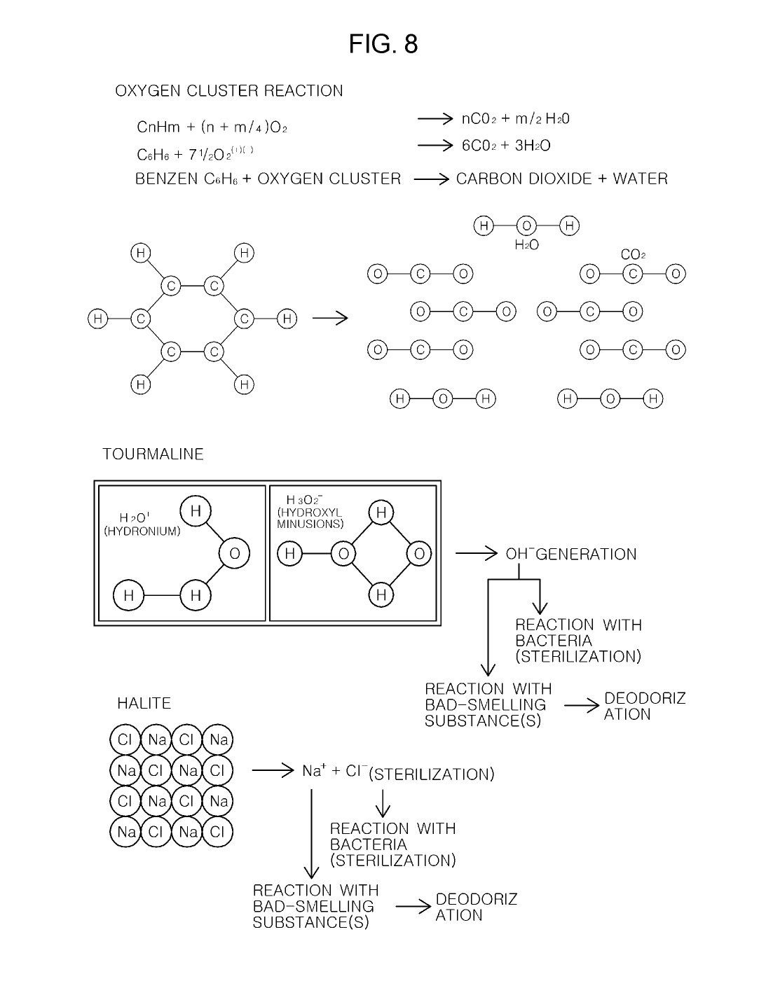

FIG. 8 is a structural view illustrating a principle of generating negative ions by the negative ion mortar layer 3e shown in FIGS. 3 and 4.

The negative ion mortar layer 3 is disposed on the lower plate 2 of the panel, such that the negative ion mortar layer 3 is filled between the springs 7, as the vibration-proof layer, by a uniform thickness of approximately 10 mm. Far-infrared rays and negative ions generated from the negative ion mortar layer react with formaldehyde (HCHO) and volatile organic compounds (VOCs) to break molecular rings of the formaldehyde and the volatile organic compounds, such that the volatile organic compounds (VOCs) are converted into carbon dioxide and vapor by an oxygen cluster reaction to couple oxygen and organic compounds, thereby purifying contaminated room air. Furthermore, the negative ion mortar layer 3 includes powder of tourmaline, illite, halite, geolite, pottery stone, and ceramic, which emit far-infrared rays and negative ions acting as main components of the negative ion mortar layer 3, and natural adhesive, to generate hydroxyl minus ions (H₃O₂—), hydroxyl ions (OH—), and natural chlorine ions (Cl—), which exhibit a high sterilizing force, thereby eradicating ticks, mold, floating bacteria inhabiting rooms through a strong sterilizing action, i.e., achieving a natural insect-destroying effect. In addition, as a result of the eradicating of ticks, mold, floating bacteria, and microorganisms, it is possible to remove a source of microbial VOCs (MVOCS: a kind of mold smell) emitted from the microorganisms during the metabolism of the microorganisms. Also, it is possible to suction or discharge moisture through a large number of micro pores, having a size of 0.01 μm to 1 μm, of the negative ion mortar layer 3, to control the humidity of the room, thereby purifying the room air. Furthermore, the remaining far-infrared rays and the remaining negative ions, emitted from ion materials, such as the illite, the tourmaline, and geolite, are introduced into a human body through the respiratory organs and skin of the human body and then react with positive ions in the human body to ionize a mineral component of blood, thereby alkalizing the blood and thus improving health.

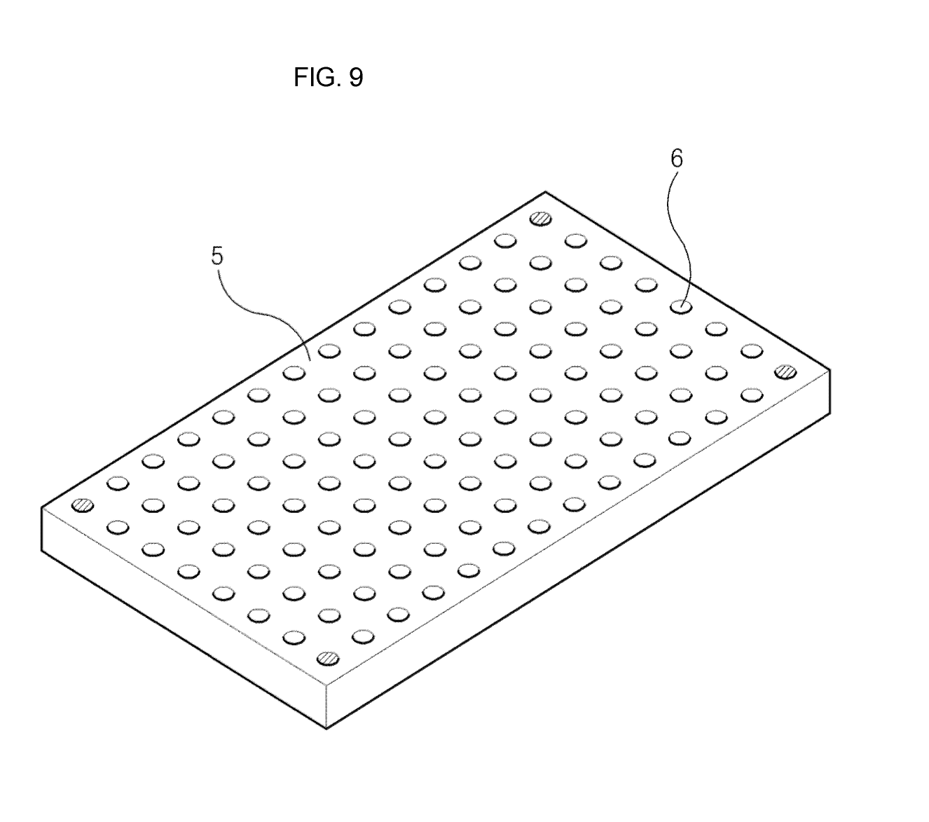

FIG. 9 is a longitudinal sectional view illustrating the structure of the porous sound-absorbing material 5 shown in FIGS. 3 and 4. The porous sound-absorbing material 5 is interposed between the negative ion mortar layer 3 and the upper plate 8, such that the porous sound-absorbing material 5 covers the plurality of springs 7, to absorb noise energy incident upon the panel with the resistance of a porous fiber material, thereby achieving the sound absorption effect. At this time, the porous sound-absorbing material 5 has high density and is treated to have fire retardancy, thereby absorbing the incident noise energy, i.e., wave energy of a sound wave, through an irreversible change process into the form of thermal energy.

According to this embodiment of the present invention, the porous sound-absorbing material is made of polyurethane foam fiber or rock wool that is soft, rough at the surface thereof, and has sufficient density and porosity, thereby partially absorbing noise energy transmitted into the panel, and, in addition, is treated to have fire retardancy at the surface thereof such that the porous sound-absorbing material exhibits incombustibility. Alternatively, the porous sound-absorbing material 5 may be made of a foam resin material and an inorganic fiber sound-absorbing material that is soft, rough at the surface thereof, porous, has a good sound-absorption property at a middle and high sound range, and has a sound absorption property at a low sound range increased by increasing the thickness of the material and the thickness of a discharged air layer.

However, the present invention is not limited to the above-mentioned materials. For example, (1) glass wool, (2) rock wool, (3) an inorganic fiber sound-absorbing material, (4) a foam resin material, and (5) glass wool, rock wool, stainless wool, a cork sheet, a plaster board, sand, and concrete block made of other textile felt may be used as the porous sound-absorbing material.

The porous sound-absorbing material 5 is made of polyurethane foam fiber or rock wool that stores solid-borne sound transmitted into the panel, mechanical energy, and noise energy by the viscosity of air between a plurality of fiber layers of the porous sound-absorbing material.

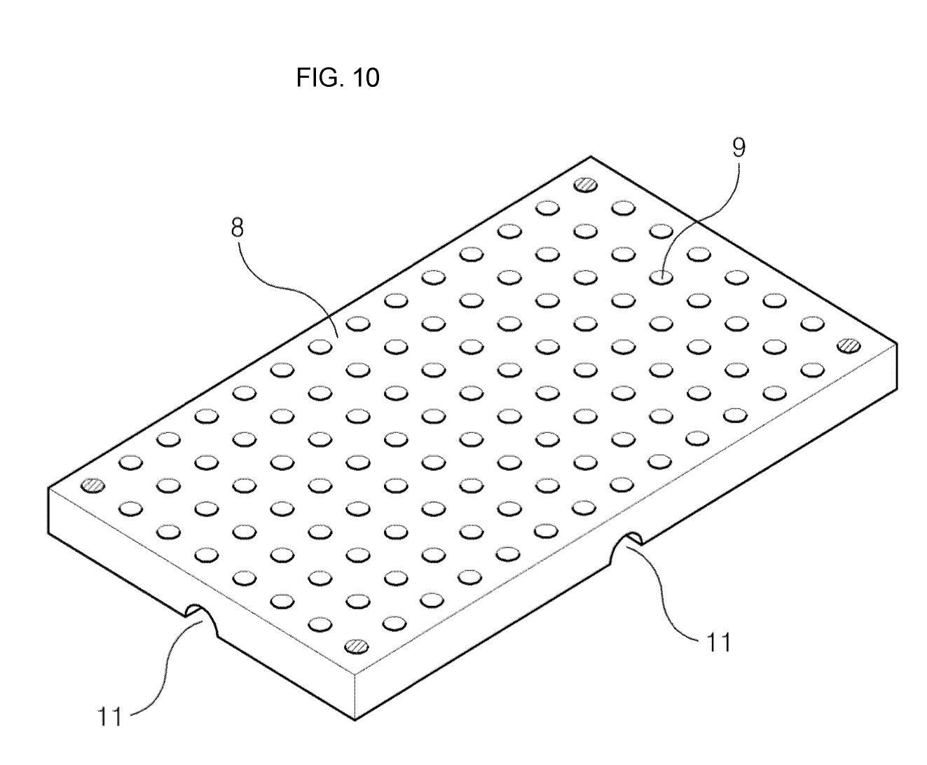

FIG. 10 is a view illustrating the upper plate 8 shown in FIGS. 3 and 4. The upper plate 8 covers the porous sound-absorbing material 5. A plurality of sound-absorbing holes 9 are formed at the metal-based (Al, steel) surface of the upper plate 8. Noise energy incident upon the panel is absorbed by the porous sound-absorbing material 5 and the negative ion mortar layer 3. The remaining noise energy is absorbed by the upper plate 8, whereby the sound absorption efficiency is improved.

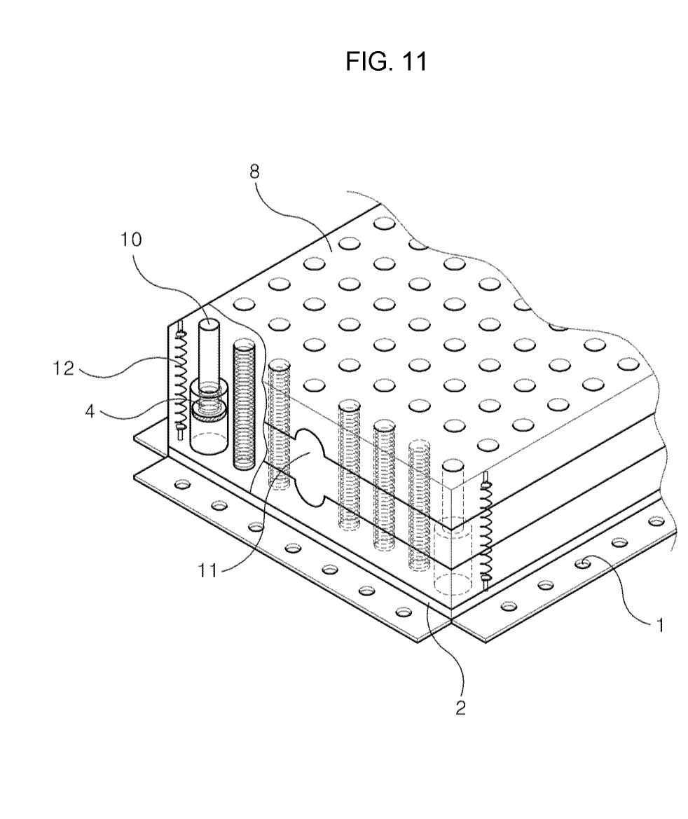

FIG. 11 is a structural view illustrating the installation of piston pins, sleeves, and separation preventing members shown in FIGS. 3 and 4.

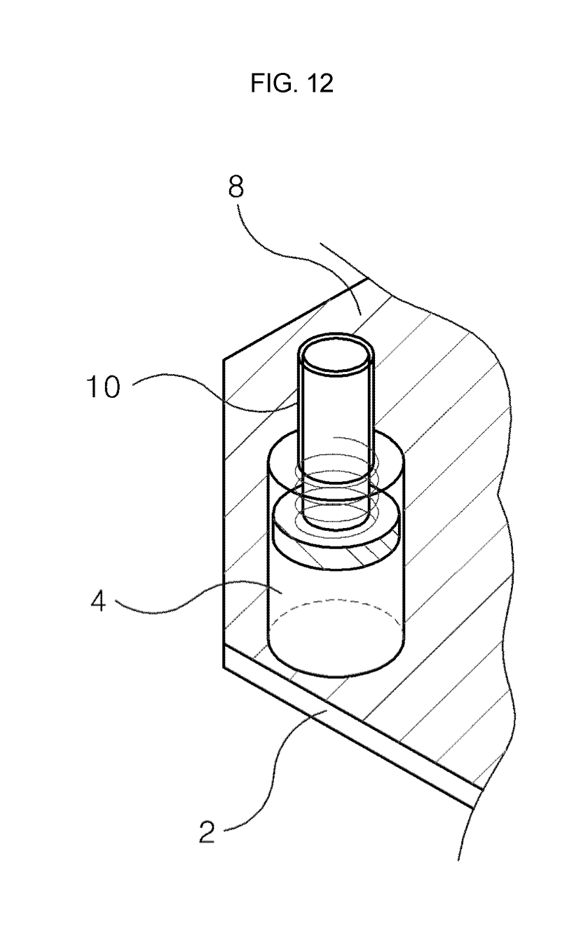

FIG. 12 is an enlarged view illustrating the installed state of one piston pin 10 and one corresponding sleeve 4 shown in FIG. 11. The interfloor noise reduction panel for buildings further includes a piston pin 10 attached to at least one of the corners and the central part of the panel, such that the piston pin extends downward from the upper plate 8, for preventing the separation between the lower plate and the upper plate due to external impact, and a sleeve 4 mounted in the lower plate for receiving the piston pin.

The piston pin 10 prevents the separation between the lower plate and the upper plate due to impact applied to the panel and a repulsive force of a spring 3, and prevents the deformation of the lower plate and the upper plate.

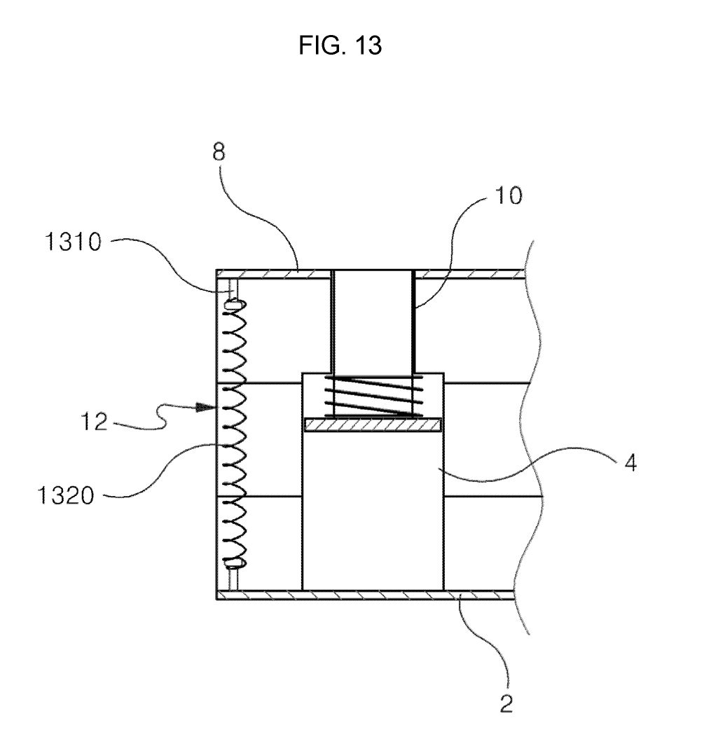

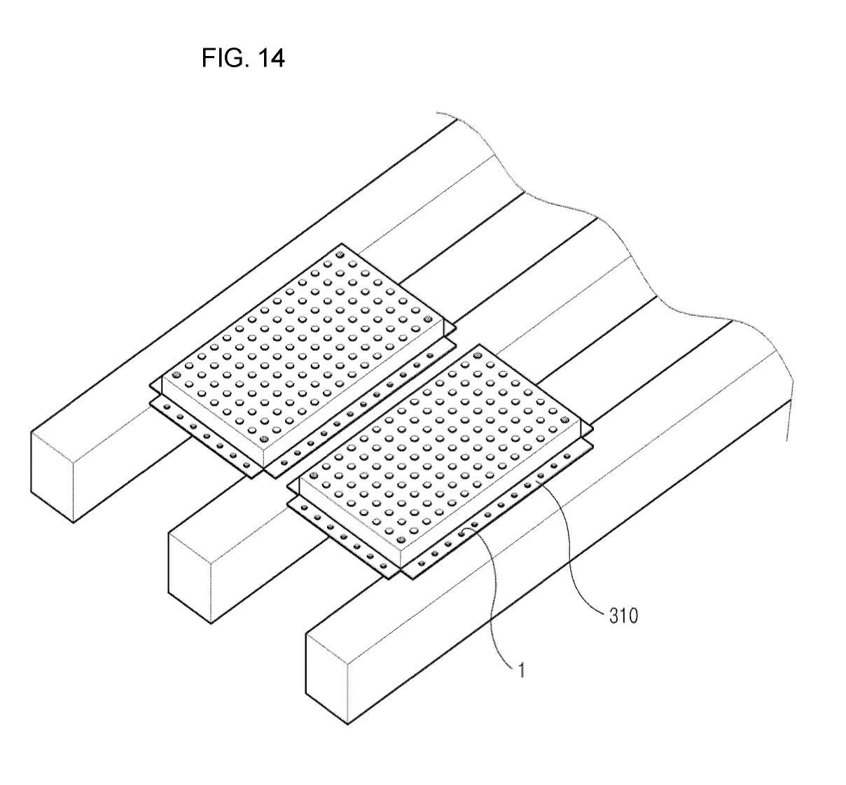

FIG. 13 is an enlarged view of the separation preventing member 12 shown in FIG. 11. The interfloor noise reduction panel for buildings further includes a separation preventing member 12. The separation preventing member 12 comprises a pair of connection rings 1310 and a rope 1320 connected between the connection rings 1310. The separation preventing member 12 prevents the lower plate 2 and the upper plate 8 from separating from each other by the repulsive force of the spring 7 when the springs 7 are compressed, due to external impact and vibration applied to the panel, and then return to their original positions.

Between the lower plate 2 and the upper plate 8 are formed pipe penetration holes 11 through which cooling or heating pipes (not shown) penetrate such that the interference between the cooling or heating pipes and the interfloor noise reduction panel is prevented during a cooling work and a heating work.

The interfloor noise reduction panel for buildings further includes a separation preventing member, as an additional safety device, comprising connection rings and a rope, for preventing the lower plate 2 and the upper plate 8 from separating from each other by the repulsive force of the spring 7 when the springs 7 are compressed, due to external impact and vibration applied to the panel, and then return to their original positions.

Hereinafter, the operation of the present invention will be described in more detail with reference to the accompanying drawings.

The upper plate 2 of the panel, having the sound-absorbing holes formed at the surface thereof, and the natural inorganic mortar layer 3, emitting far-infrared rays and negative ions, are provided to improve sound absorption efficiency. The far-infrared rays and the negative ions emitted from the mortar layer 3 purify room air and sterilizes bacteria in the room. For easy disassembly and installation of the interfloor noise reduction panel, the panel fixing holes 1, having a size of approximately 5 mm, are formed in the guide planes 310 of the lower plate of the panel in consideration of the convenience in construction, whereby the construction and replacement of the interfloor noise reduction panel is easily achieved.

As is generally known, modern buildings are designed, such that the buildings are isolated more accurately from the outside, to improve a heat effect and a sound-proof effect. As a result, an indoor resident frequently lives in a room filled with contaminated air. In fact, the contaminated room air contains volatile organic compounds (VOCs: components of benzene, toluene, and xylene) generated by the volatilization of a surface treatment agent and an adhesive of interior decoration materials, formaldehyde (HCHO), house dust, ticks, tobacco smoke, carbon monoxide, various kinds of mold, and viruses. The far-infrared rays and the negative ions emitted from the mortar layer 3 break the molecular structure of the above-mentioned substances to purify the air. At this time, a reaction formula, i.e., a reaction formula for bad smell removal, is represented as follows.

CnHm+(n+m/4)O₂= [symbol] nCO₂+m/2H₂O

C₆H₆+71/2O₂= [symbol] 6CO₂+3H₂O

Benzene(C₆H₆)+Oxygen cluster= [symbol] Carbon dioxide+Water REACTION FORMULA 1

The far-infrared rays and negative ions have another function. Referring to FIG. 8, a high oxidizing power (sterilizing, disinfecting, decomposing abilities) of hydroxyl minus ions (H₃O₂—), hydroxyl ions (OH—), and natural chlorine ions (Cl—), generated from tourmaline, sterilizes ticks, viruses, mold, and floating bacteria in a contact fashion to eradicate the ticks, the viruses, the mold, and the floating bacteria. As a result, a source of microbial VOCs (MVOCS: a kind of mold smell) emitted from the microorganisms during the metabolism of the microorganisms is removed, and moisture is adjusted through a large number of micro pores, having a size of 0.01 μm to 1 μm, formed at the surface of the negative ion mortar layer, thereby preventing asthma, a bronchial disorder, a VDT syndrome, headache, a visual disorder, nervousness, depression, dermatitis, and an allergy of an indoor resident. Furthermore, the remaining negative ions are introduced into a human body through the respiratory organs of the human body to ionize a mineral component of blood, thereby alkalizing the blood and thus purifying the blood. Also, substance interchange at the cell membrane is smoothly carried out by the sufficient negative ions, with the result that cells are activated. In addition, the amount of globulin, an immunity component of a blood serum is increases, whereby the resisting power is increased, and therefore, the infection of the above-mentioned diseases is prevented.

The porous sound-absorbing material 5, having a thickness of approximately 25 mm to 50 mm and a plurality of pores formed therein, is installed on the negative ion mortar layer 3 while the plurality of springs 7 are fitted in the respective holes of the porous sound-absorbing material, which are sufficient largely for the springs to be compressed and return to their original states without difficulty.

The piston pins 10 for separation prevention are attached to the upper plate 8 of the panel, contacting the upper ends of the springs 7 and having a plurality of sound-absorbing holes 9 formed at the surface thereof, at the respective corners and the central part of the upper plate 8 of the panel, such that the piston pins 10 extend downward from the upper plate, to prevent the separation between the upper plate and the lower plate due to external impact. In addition to the piston pins 10 for separation prevention, a separation prevention member mechanism 12 including a pair of circular connection rings 1310 for secondary separation prevention and a rope 1320 connected between the pair of connection rings 1310 is installed at each corner of the panel. Also, the upper plate 8 of the panel is bent downward by approximately 20 mm at the respective edges of the four sides of the panel such that the upper plate 8 constitutes a uniform shape together with the lower plate 2 of the panel when external impact and vibration are applied to the upper plate 8.

Especially, the holes 9 of the upper plate 8 of the panel exhibit the property of a resonance type sound-absorbing material. Consequently, noise energy transmitted to the panel is introduced into the holes 9 in conjunction such that the noise energy is extinguished as frictional heat during the vibration. Furthermore, a series of movements including a downward movement of the upper plate 8 of the panel, to which the plurality of springs 7 are connected, by external impact and vibration applied to the upper plate 8 of the panel and a returning movement of the upper plate 8 of the panel to its original position serve as a pump of a fluid machine, and the holes 9 formed in the upper plate 8 of the panel serve as spray nozzles. Consequently, the emission distance of the far-infrared rays and the negative ions generated from the negative ion mortar layer 3 is increased.

When impact and vibration are applied to the upper and lower plates of the panel, the repulsive force and compressed displacement of the springs with respect to the surfaces of the upper and lower plates of the panel exhibit anisotropy along the direction of a force applied to the surfaces of the upper and lower plates of the panel, with the result that it is easy for the upper and lower plates of the panel to separate from each other by a property to separate in a specific direction. In order to solve the separation phenomenon, the sleeves 4 are installed on the top surface of the lower plate 2 of the panel, and the piston pins 10 are installed at the bottom surface of the upper plate 8 of the panel. The inner diameter of sleeves 4 is slightly greater than the piston pin 10, whereby the friction during the rectilinear movement of the piston pins 10 is minimized. The entrance of the sleeves 4 is flared in the shape of a trumpet, whereby the insertion of the piston pins 10 is easily achieved although the insertion direction of the piston pins varies.

The connection rings are installed at the respective corners of the upper and lower plates of the panel, the wire rope 1320, having a predetermined size and length, are connected between the corresponding rings, thereby preventing the separation between the upper and lower plates of the panel due to external impact applied to the upper and lower plates of the panel and the repulsive force of the springs 7 generated by the external impact. Also, the upper plate 8, the lower plate 2, the springs 7, and the wire ropes for panel separation prevention are treated (coated or surface-treated) to have corrosion protection in order to increase the durability of the upper plate 8, the lower plate 2, the springs 7, and the wire ropes.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

The present invention can be used as an interfloor noise reduction panel for apartment houses, office buildings, and factories.

What is claimed is:

1. An interfloor noise reduction panel with air purifying and sterilizing functions for buildings, comprising:
a lower plate having an approximately rectangular body, which is horizontally installed at the floor of the building in contact with the floor to reduce noise transmitted to the floor;
a vibration-proof layer disposed on the lower plate for damping and absorbing vibration and impact transmitted to the lower plate with elastic energy to alleviate a wave resonance effect of the floor;
a negative ion mortar layer disposed between the lower plate and the vibration-proof layer to purify contaminated room air with far-infrared rays and negative ions generated from the negative ion mortar layer;
a porous sound-absorbing material disposed on the negative ion mortar layer to absorb noise energy incident upon the panel with the resistance of a porous fiber material; and
an upper plate for covering the porous sound-absorbing material, the upper plate having a plurality of sound-absorbing holes formed therein for, after the noise energy incident upon the panel is absorbed by the porous sound-absorbing material and the negative ion mortar layer, absorbing the remaining noise energy.

2. The interfloor noise reduction panel according to claim 1, wherein the lower plate is formed of any one selected from a group consisting of steel, aluminum, and concrete constructed such that the weight and planar density of a material that is capable of reducing energy incident upon or transmitted through the interfloor noise reduction panel for buildings to greatly improve a sound insulation effect are maintained densely.

3. The interfloor noise reduction panel according to claim 1, wherein a guide plane having at least one panel fixing hole formed therein is attached to the lower plate such that the guide plane extends outward.

4. The interfloor noise reduction panel according to claim 1, further comprising a vibration-proof rubber plate or a felt plate attached to the bottom of the lower plate for reducing the transmission of solid-borne sound to the panel.

5. The interfloor noise reduction panel according to claim 1, wherein the vibration-proof layer includes a plurality of springs or vibration-proof rubber members having a great selection range with respect to the number of natural frequencies transmitted to the panel, a damping efficiency, high low-frequency vibration insulation, and high heat resistance.

6. The interfloor noise reduction panel according to claim 5, wherein the negative ion mortar layer includes illite, tourmaline, geolite, and pottery stone disposed between the springs on the lower plate for purifying contaminated room air and sterilizing microorganisms inhabiting a room with far-infrared rays and negative ions emitted from the illite, the tourmaline, the geolite, and the pottery stone, and natural inorganic matter disposed between the springs on the lower plate for controlling humidity through a large number of micro pores formed at the surface thereof.

7. The interfloor noise reduction panel according to claim 1, wherein the porous sound-absorbing material has high density and is treated to have fire retardancy, thereby absorbing the noise energy, i.e., wave energy of a sound wave, through an irreversible change process into the form of thermal energy.

8. The interfloor noise reduction panel according to claim 1, wherein the porous sound-absorbing material is made of a foam resin material and an inorganic fiber sound-absorbing material that is soft, rough at the surface thereof, porous, has a good sound-absorption property at a middle and high sound range, and has a sound absorption property at a low sound range increased by increasing the thickness of the material and the thickness of a discharged air layer.

9. The interfloor noise reduction panel according to claim 1, wherein the porous sound-absorbing material is made of polyurethane foam fiber or rock wool that stores solid-borne sound transmitted into the panel, mechanical energy, and noise energy by the viscosity of air between a plurality of fiber layers of the porous sound-absorbing material.

10. The interfloor noise reduction panel according to claim 1, wherein further comprising a piston pin attached to at least one of the corners and the central part of the panel, such that the piston pin extends downward from the upper plate, for preventing the separation between the lower plate and the upper plate due to external impact, and a sleeve mounted in the lower plate for receiving the piston pin.

11. The interfloor noise reduction panel according to claim 1, further comprising a separation preventing member including a pair of connection rings and a rope connected between the connection rings for preventing the lower plate and the upper plate from separating from each other due to external impact and vibration applied to the panel.

12. The interfloor noise reduction panel according to claim 1, further comprising pipe penetration holes formed between the lower plate and the upper plate for allowing cooling or heating pipes to penetrate therethrough, thereby preventing the interference between the cooling or heating pipes and the interfloor noise reduction panel.
